(19) United States
(12) Patent Application Publication
(10) Pub. No.: US 2026/0257419 A1
(43) Pub. Date: Sep. 3, 2026

(54) ADDITIVE MANUFACTURING SYSTEM WITH ROTATABLE DEPOSITION HEAD AND INTEGRATED MATERIAL FEED

(71) Applicant: Electroimpact, Inc., Mukilteo, WA (US)

(72) Inventors: Michael M ZIEVE, Seattle, WA (US); Ryan L. BISCHOFF, Shoreline, WA (US); Andrew PURVIS, Mukilteo, WA (US); Mason LEACH, Seattle, WA (US)

(21) Appl. No.: 19/554,640

(22) Filed: Mar. 2, 2026

Related U.S. Application Data
(60) Provisional application No. 63/766,360, filed on Mar. 3, 2025.

(51) Int. Cl. B29C 64/209; B29C 64/241; B29C 64/336; B33Y 10/00; B33Y 30/00; B33Y 40/00

(52) U.S. Cl. CPC B29C 64/209; B29C 64/241; B29C 64/336; B33Y 10/00; B33Y 30/00; B33Y 40/00

(57) ABSTRACT

An additive manufacturing machine (AMM) features a deposition head capable of rotation in a range of 360 degrees or more relative to a material holder. A material pathway delivers additive manufacturing material to the deposition head. This pathway either utilizes a rotary union with the material routed internally or externally or comprises a flexible conduit with a support system. A two-stage material supply is also described. This rotation capability facilitates a consistent path-relative deposition orientation for improved process control.

### CROSS-REFERENCE TO RELATED APPLICATION

This application claims the 3, 2025, which is incorporated by reference herein in its entirety.

### BACKGROUND

Additive manufacturing machines (AMMs) face challenges in transferring additive manufacturing material to a rotating deposition head. This limitation restricts the rotational freedom of the deposition head, complicating the manufacture of parts with complex geometries. Furthermore, achieving a consistent deposition orientation is difficult when the deposition head's orientation is constantly changing relative to the part, impacting the integration of process monitoring and control components. Background information discussed herein is presented for illustrative purposes only and should not be attributed to the present invention.

### SUMMARY OF THE DISCLOSURE

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

The present disclosure relates to additive manufacturing machines (AMMs) and improvements to their material delivery systems for enabling rotation of a deposition head. A key feature is the deposition head's ability to rotate in a range of 360 degrees or more relative to a material supply without interrupting material flow.

According to an embodiment, an AMM includes a material holder, a deposition head, a motion system, a rotary union, a control system, and a material pathway. The material holder is configured to supply an additive manufacturing material. The deposition head is configured to receive the additive manufacturing material. A motion system is configured to move the deposition head and position the deposition head in at least two-dimensional space. The rotary union has a first portion and a second portion, the second portion being operatively coupled to the deposition head and rotatable with respect to the first portion. The rotary union thus couples the material supply device to the deposition head, allowing for rotation of the deposition head independent from at least portions of the material holder. The control system is configured to control rotation of the deposition head about a rotational axis, and the rotary union is configured to facilitate the rotation of the deposition head about the rotational axis within a rotation range of at least 360 degrees. The material pathway is disposed and configured to convey the additive manufacturing material from the material holder via a first, supply-side portion of the material pathway across the rotary union to a second, delivery-side portion of the material pathway at or proximate the deposition head. The delivery-side portion of the material pathway may be rotatable with the deposition head about the rotational axis. The material pathway conveys.

According to another embodiment, an AMM includes a primary material holder, an end-effector material holder, a deposition head, a motion system, a rotary union, a control system, and a transfer mechanism. The primary material holder is configured to supply an additive manufacturing material. The end-effector material holder is mounted on an end-effector of the AMM, and is configured to receive the additive manufacturing material from the primary material holder. The deposition head is operably connected to the end-effector and is configured to receive the additive manufacturing material from this end-effector material holder and to deposit the additive manufacturing material on a substrate or workpiece. The motion system is configured to move the deposition head and position the deposition head in at least two-dimensional space. The rotary union is operatively coupled to the deposition head. The control system is configured to control rotation of the deposition head about a rotational axis in a range of 360 degrees or more, and the transfer mechanism is configured to at least intermittently replenish or replace the end-effector material holder with additive manufacturing material from the primary material holder.

According to another embodiment, an AMM may include a material holder, a deposition head, a motion system, a flexible material pathway, a support system, and a control system. The material holder is configured to supply an additive manufacturing material to the deposition head. The deposition head is configured to receive the additive manufacturing material from the material holder and to deposit the additive manufacturing material on a substrate or workpiece. The deposition head is further configured to perform at least one of: extruding the additive manufacturing material, mixing and extruding the additive manufacturing material, jetting the additive manufacturing material, directing energy to consolidate the additive manufacturing material, depositing the additive manufacturing material, and shaping the additive manufacturing material during or after deposition. The motion system is configured to move the deposition head and position the deposition head in at least two-dimensional space. The flexible material pathway extends between the material supply holder and the deposition head, and has a length greater than a linear distance between the material holder and the deposition head to define a service loop. The support system is provided to maintain the service loop in a non-linear configuration, preventing kinking or blockage while accommodating flexing of the service loop during rotation. The control system is configured to rotate the deposition head about a rotation axis within a rotation range of at least 360 degrees, the support system accommodating a changing arrangement of the service loop to supply the additive manufacturing material to the deposition head while the deposition head rotates and maintains a continuous material pathway.

The disclosure encompasses corresponding methods of additive manufacturing:

According to an embodiment, a method of additive manufacturing includes an operation of operatively coupling a deposition head to an automated manufacturing machine (AMM) using a rotary union that facilitates rotation of the deposition head about a rotational axis. The method also includes an operation supplying an additive manufacturing material from a material holder to the deposition head. The method further includes an operation of moving the deposition head in at least two-dimensional space using a motion system. In addition, the method includes an operation of depositing, with the deposition head, the additive manufacturing material on a substrate or workpiece. The rotary union facilitates rotation of the deposition head about a rotational axis in a range of 360 degrees or more. The supplying of an additive manufacturing material from the material holder to the deposition head includes delivering the additive manufacturing material via a material pathway, the material pathway being disposed and configured to convey the additive manufacturing material from a first, supply-side portion of the material pathway across the rotary union to a second, delivery-side portion of the material pathway proximate the deposition head, the delivery-side portion of the material pathway being rotatable with the deposition head about the rotational axis, the supply-side portion of the material pathway being fixed relative to the motion system. The material pathway includes a pathway disposed externally around the rotary union and/or at least one internal passage within the rotary union.

According to another embodiment, a method of additive manufacturing includes an operation of supplying an additive manufacturing material from a main material holder. The method also includes an operation of depositing the additive manufacturing material from a deposition head. The method further includes an operation of moving the deposition head in at least two-dimensional space using a motion system. Further, the method includes operations of operatively coupling a rotary union between the motion system and the deposition head and rotating the deposition head within a range of at least 360 degrees about a rotational axis. Still further, the method includes an operation of supplying the additive manufacturing material directly to the deposition head from an end-effector material holder mounted on an end-effector of the additive manufacturing machine. Additionally, the method includes an operation of replenishing the end-effector material holder at least intermittently with additive manufacturing material from the main material holder via a transfer mechanism.

According to another embodiment, a method of additive manufacturing includes operations of: supplying an additive manufacturing material from a material holder to a deposition head via a flexible material pathway having a length greater than a linear distance between the material holder and the deposition head to define a service loop; moving the deposition head in at least two-dimensional space using a motion system; rotating the deposition head about a rotation axis within a rotation range of at least 360 degrees; depositing the additive manufacturing material from the deposition head onto a substrate or workpiece; and maintaining the service loop in a non-linear configuration and accommodating a changing geometry of the service loop to maintain a continuous material pathway during said movement and rotation.

It is understood that the following disclosure provides many different embodiments, or examples, for implementing different features of the invention. Specific examples of components and arrangements are described below to simplify the present disclosure. These are, of course, merely examples and are not intended to be limiting.

Further scope of applicability of the present invention will become apparent from the Detailed Description given below. However, it should be understood that the Detailed Description and specific examples, while indicating preferred embodiments of the invention, are given by way of illustration only, since various changes and modifications within the spirit and scope of the invention will become apparent to those skilled in the art from this Detailed Description.

### BRIEF DESCRIPTION OF THE DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1A is a block diagram illustrating the flow of additive manufacturing material across a rotary union, according to an embodiment;

FIG. 1B is a schematic overview of an additive manufacturing machine (AMM) according to an embodiment of the invention, illustrating a material holder, rotary union, deposition head, material pathway, and material conveyance system, according to an embodiment;

FIG. 1C is a block diagram illustrating flow of an additive manufacturing material around a rotary union using a material conveyance system, according to an embodiment;

FIG. 2 is a perspective view of a material conveyance system integrated with a rotary union, illustrating the material conveyance system functionality, according to an embodiment;

FIGS. 3A and 3B are perspective views of a slip ring component of a rotary union, illustrating transfer of electrical and pneumatic utilities across a rotary axis and an internal passage for additive manufacturing material, according to an embodiment;

FIG. 4 is a perspective view of a rotary union assembly integrated with a flexible auger-based material conveyance system, illustrating a first embodiment of the material pathway, according to an embodiment;

FIG. 5 is a perspective view of a rotary union assembly integrated with a sideways cupped belt-based material conveyance system, illustrating the material pathway, according to an embodiment;

FIG. 6 is a perspective view of a rotary union assembly integrated with a chained conveyor-based material transfer system, illustrating the material pathway, according to an embodiment;

FIG. 7A is a block diagram illustrating the flow of additive manufacturing material through a rotary union using a central bore, according to an embodiment;

FIG. 7B is a cross-sectional view of the rotary union and material pathway, illustrating a fourth embodiment where the material pathway comprises a channel passing through a central bore of the rotary union, according to an embodiment;

FIG. 8 is a cross-sectional, schematic view of a rotary union with an internal channel integrated within an AMM, according to an embodiment;

FIG. 9 is a detailed perspective view of the deposition head, showing a substrate temperature sensor, a localized laser heater, a compaction roller, a reinforcement applicator, and (not pictured) a surface treatment applicator, all arranged in a fixed, non-rotational relationship with each other and a deposition nozzle, according to an embodiment;

FIG. 10 is a detailed perspective overview of an additive end effector, illustrating process tool and material conveyance system integration with the deposition head, according to an embodiment;

FIG. 11 is a schematic diagram of a two-stage material holder, illustrating a transfer mechanism replenishing an end-effector material holder from a primary material holder, according to an embodiment;

FIG. 12 is a schematic layout of an AMM cell, illustrating a possible location for an end-effector material holder transfer or exchange, according to an embodiment; and

FIG. 13 is a schematic diagram of an alternative embodiment of the additive manufacturing machine, illustrating a flexible material pathway configured to enable rotation in a range of 360 degrees or more, according to an embodiment.

It is to be noted that the drawings are schematic in nature and are not necessarily to scale. The drawings are intended to depict only typical embodiments of the invention, and therefore should not be considered as limiting the scope of the invention. Furthermore, for the sake of illustrative clarity, certain components may be depicted in a simplified or exemplary form, such as the use of a “nozzle” in several figures to represent a generic material outlet. It is to be understood that these specific depictions are not intended to limit the scope of the disclosed concepts to that particular form. The disclosed devices and methods are capable of other and different embodiments, and several details are capable of modifications in various obvious respects, all without departing from the novel concepts disclosed herein. Accordingly, the drawings and description are to be regarded as illustrative in nature and not restrictive.

The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The primary purpose of the various embodiments described herein is to enable the deposition head of an additive manufacturing machine to rotate continuously or through an extended range (e.g. within a range of 360 degrees or more) without interrupting the flow of the additive manufacturing material. Achieving this rotational freedom provides several significant technical benefits that directly address long-standing limitations in the art.

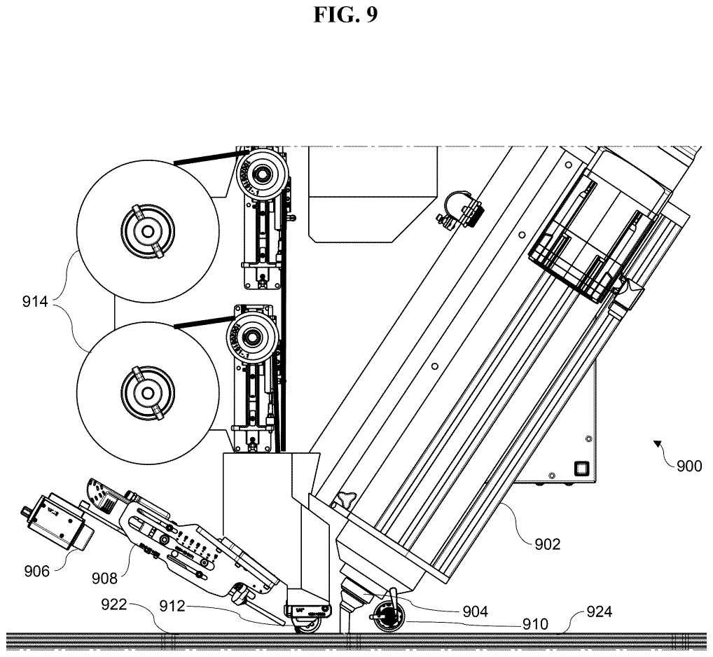

First, the disclosed embodiments of methods and of apparatus structures and arrangements dramatically improve the quality and mechanical performance of parts manufactured thereby. By continuously rotating the deposition head to maintain a constant orientation relative to the direction of travel (i.e., tangent to the toolpath), the deposited head maintains a consistent cross-sectional profile, which leads to more isotropic (uniform) material properties and greater part strength. This is achieved by a control system that processes a digital toolpath, calculates the local tangent at the point of deposition in real-time, and commands the rotary union to continuously adjust the angular position of the deposition head accordingly. This principle of maintaining a constant tool-path orientation is critical across numerous advanced additive manufacturing processes. For instance, when extruding with a non-circular nozzle for high throughput or performing Automated Fiber Placement (AFP) with a composite tape, the orientation of the nozzle or tape directly controls the structural integrity of the part; continuous rotation allows reinforcement fibers to be precisely steered along complex stress paths to bear design loads. Similarly, the effectiveness of integrated process tools is critically dependent on their orientation. A directional heater used to prepare the substrate surface, a jetting device applying a surface additive or bonding agent, or a compaction roller designed to fuse layers and reduce porosity, must all remain in a fixed leading or trailing position relative to the point of deposition. Without continuous rotation, these tools would be misaligned on curved paths, leading to inconsistent heating, poor layer adhesion, and voids in the final part that is being manufactured. This benefit also extends to processes like Directed Energy Deposition (DED), where rotation is required to maintain a consistent melt pool geometry and material properties when building or repairing features on a non-linear path. Furthermore, this consistent orientation allows process tools, such as the pre-deposition heaters and post-deposition compaction rollers shown in FIG. 9, to be applied uniformly along complex, curving paths, thereby ensuring optimal interlayer adhesion and part density.

Second, it increases manufacturing speed and efficiency. Conventional systems with limited rotation must frequently stop the deposition process to reorient the entire robotic arm or gantry, which are slow, non-value-added movements. By enabling the deposition head to rotate independently and continuously, the system can maintain higher deposition speeds along complex toolpaths without pausing, significantly reducing build times.

Third, it allows for the fabrication of parts with far greater geometric complexity. The disclosed systems and methods remove the physical limitation of twisted and tangled feed lines, unlocking the potential to manufacture parts with intricate, non-linear, and multi-planar features that were previously difficult or impossible to produce.

Finally, it simplifies and enhances the integration of in-process monitoring and control.

With a predictable and constant tool-point orientation, sensors, inspection cameras, and other control elements can be mounted directly on an end effector in a fixed, optimal position relative to the deposition point, leading to more reliable data collection and enabling more sophisticated closed-loop process control. Specifically, the system may incorporate in-situ metrology via visual inspection cameras mounted in a fixed relationship to the deposition nozzle. Because the deposition head maintains a constant orientation relative to the toolpath, the inspection cameras receive a consistent, unobstructed view of the melt pool and the trailing bead. This consistency allows the defect detection algorithms to perform real-time, layer-by-layer analysis—identifying anomalies such as over-extrusion, under-extrusion, or geometric deviations—without the noise and perspective shifts introduced by traditional non-rotating or limited-rotation systems.

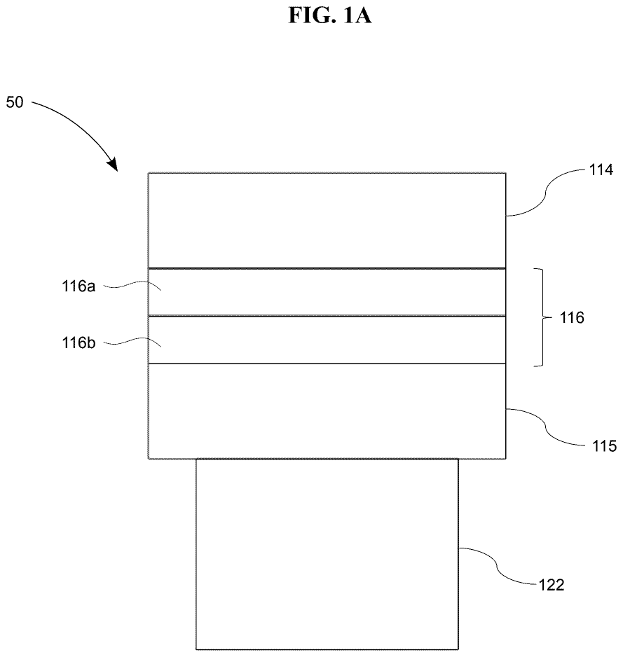

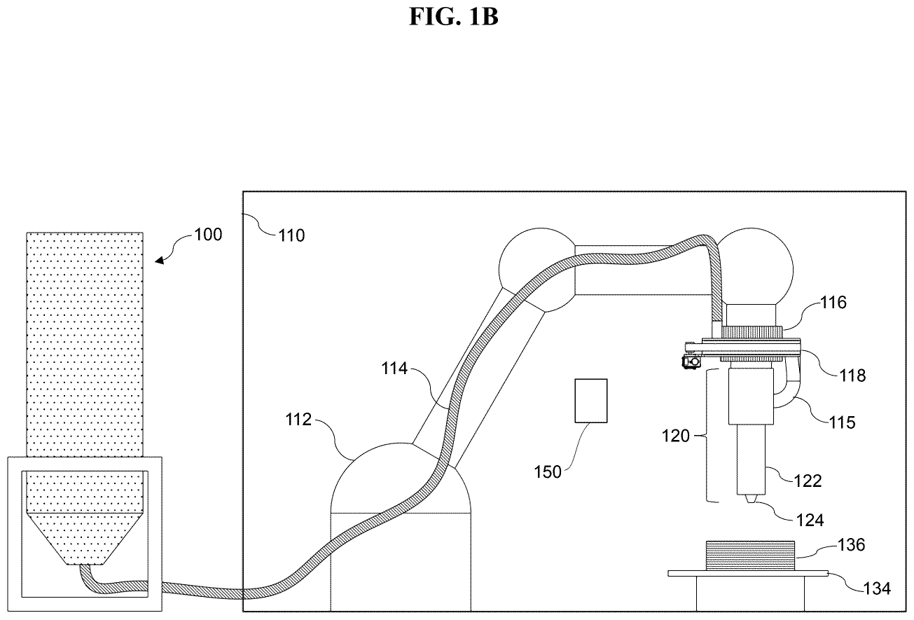

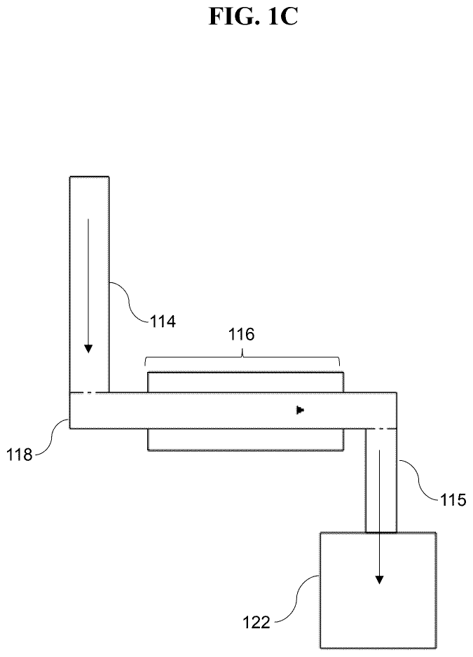

FIG. 1A is a block diagram illustrating elements 50 of an Additive Manufacturing Machine (AMM) according to an embodiment. The AMM may include a rotary union 116 with a first portion 116a and a second portion 116b, in which the second portion 116b is rotatable with respect to the first portion 116a and is operatively coupled to a deposition head 122. Additive manufacturing material is received across the rotary union 116 via a material pathway that includes a first, supply-side portion 114 and a second, delivery-side portion 115. The additive manufacturing material first travels from a material supply 100 through the supply-side portion 114 of the material pathway. The delivery-side portion 115 of the material pathway is rotatable with respect to the supply-side portion 114 of the material pathway. The additive manufacturing material then travels across the rotary union 116 to the delivery-side portion 115 of the material pathway. The additive manufacturing material then reaches the deposition head 122 for extrusion or other processes.

FIG. 1B shows a schematic overview of an embodiment of an AMM, using a material conveyance system 118 to direct additive manufacturing material to a rotatable deposition head 122. The AMM comprises a material holder 100 located adjacent to and external to an AMM build cell 110. The AMM build cell 110 may comprise an enclosure or room that may have temperature or humidity control and laser safety features or could just be an area that substantially surrounds the potential build area of the AMM. The material holder 100 stores the additive manufacturing material and may include heating and drying capabilities to prepare the material for processing. The material holder 100 may include a hopper, a container, a pile, or other means for holding additive material used by an AMM. Inside the AMM build cell 110 is a motion system 112 with an end effector 120. As used herein, the “end effector” refers to the entire assembly mounted to the motion system that rotates and performs the additive manufacturing operation, while the “deposition head” refers to the specific component within the end effector that processes and dispenses the material.

The motion system 112 is shown in the figures as an articulated robot arm. However, those having skill in the art will acknowledge that the motion system 112 may be or include any type of motion system including, but not limited to, a cartesian gantry, a SCARA robot, a delta robot, or a hybrid system combining robotic or machine motion with a moving build plate or workpiece positioner. The motion system 112 may further include a combination of a traditional motion system such as an articulated robot or machine in combination with a positioning system for a build plate 134. The motion system 112 is configured to accurately move the deposition head 122 relative to a workpiece 136 which is manufactured on a build plate 134 or other work surface which may include any combination of tool or rotator in various configurations including a horizontal rotator or a vertical rotator.

Mounted on the end effector 120 is the deposition head 122 with a nozzle 124, the nozzle being the port for which the additive material is deposited through sometimes referred to as extrusion nozzle or deposition nozzle. The deposition head 122 may include a mechanism for melting and extruding the additive manufacturing material, and the associated nozzle 124 for depositing the molten thermoplastic material in a controlled manner. The motion system 112 includes the rotary union 116 configured to rotate the end effector 120 and deposition head 122.

The rotary union 116 also provides a rotatable mechanical and electrical connection, allowing rotation in a range of 360 degrees or more about its rotational axis. This rotation is a key feature of the invention. To transfer the material from the material holder 100 to the nozzle 124, the material is first transported through the supply-side portion of the material pathway 114. The material then is transferred through the material conveyance system 118 to the delivery-side portion of the material pathway 115. The delivery-side portion of the material pathway 115 feeds the additive manufacturing material to the deposition head and the nozzle. The material conveyance system 118 is configured to actively move the additive manufacturing material (e.g., pellets) around the rotary union 116, ensuring a consistent supply of additive manufacturing material from the material holder 100 to the deposition head 122. The material conveyance system 118 may employ various mechanisms, including, but not limited to, pneumatic pressure, vacuum pressure, a mechanical auger, a belt, a chain, or a combination thereof. Subsequent figures detail various implementations of the material conveyance system 118 and material pathway 115. Variations of the system are contemplated, including, but not limited to, the location of the material holder 100 within the AMM build cell 110, or using a motion platform (e.g., a Cartesian machine) other than an articulated robot arm 112. Furthermore, the deposition head 122 may constitute the entire end effector, or the end effector may incorporate multiple deposition heads.

The end effector, with its associated deposition head(s) may also be a modular and detachable unit, allowing it to be exchanged on or removed from the motion system 112 and corresponding AMM. In one embodiment, the deposition head 122 is configured as a quick-connect modular unit. This modularity allows the AMM to be rapidly reconfigured for different manufacturing modalities, such as swapping a Fused Granulate Fabrication (FGF) pellet-extrusion module for a Directed Energy Deposition (DED) metal-powder module or an Automated Fiber Placement (AFP) module. The quick-connect interface may include standardized electrical, pneumatic, and/or material couplings that automatically align and seal upon installation. This facilitates offline servicing or tool changes without requiring the disassembly or suspension of the motion system's operations, thereby minimizing machine downtime.

FIG. 1B illustrates an exemplary end effector, specifically a pellet extruder utilized for FGF. While this specific embodiment demonstrates pellet extrusion, those having skill in the art will acknowledge that the inventive principles extend to a broad spectrum of end effector functionalities. Notably, the disclosure encompasses end effectors capable of material mixing and deposition, wherein multiple additive manufacturing materials or components are combined on the end effector to form a resultant additive manufacturing material that is subsequently deposited or extruded. Such a deposition head 122 may include a static or dynamic mixer element (not shown) upstream of the nozzle to ensure a homogenous mixture of the materials before deposition. Furthermore, the concept includes Automated Fiber Placement (AFP) utilizing tows and/or tapes for precise material deposition. The disclosure also encompasses jetting processes, wherein materials are selectively ejected or deposited in a controlled manner, including but not limited to, the application of liquid binders, photopolymers, powdered materials, or other additive manufacturing materials. Concerning Directed Energy Deposition (DED), the invention extends to variations wherein directed energy, including but not limited to, the use of wire or powder as feedstock, is used to melt and fuse material onto a substrate, including but not limited to, the use of laser beams, electron beams, or plasma arcs as energy sources.

Selective material metering is another contemplated end effector functionality, enabling precise control over material flow, encompassing on/off states, volume, and flow rate adjustments. Additionally, end effectors capable of energy direction, which facilitate material processing or shaping through directed energy, are within the scope of this disclosure. The disclosure also includes deposition end effectors that deposit material in a specific location, wherein the material flow and/or properties are controlled elsewhere in the system and are routed to the deposition head 122. Finally, the disclosure includes end effectors designed for post-deposition shaping, enabling the manipulation of the additive manufacturing material during or after deposition to achieve desired geometries and surface finishes. This comprehensive range of end effector functionalities underscores the broad applicability of the inventive principles described herein. To be clear, the term “deposition head” as used throughout this disclosure is not limited to the extrusion-style head with a ‘nozzle’ shown in the exemplary figures. The specific form of the deposition head and its functional material outlet will vary depending on the additive manufacturing process being used. For instance, in a Directed Energy Deposition (DED) process, the head may comprise energy focusing optics and a powder feed conduit; in a jetting process, it may be a printhead with an array of micro-orifices; and in Automated Fiber Placement (AFP), it may include guides and a compaction roller. Therefore, the depiction of a nozzle in the figures is a non-limiting example of a material outlet, intended to represent the broader concept of any functional point of deposition or material emission suitable for the additive manufacturing processes described herein. It is further understood that the disclosed embodiments are applicable to a wide variety of additive manufacturing material in various formats including particulate, fluid, semi-fluid, powder, granules, pellets, flakes, chopped fiber, noodles, slugs, strands, fluid, paste, gel, slurry, emulsion, suspension, resin, and wax, filament, continuous fiber, wire, tow, tape, rods, sheet, and bars.

The operation of the AMM, including the coordination of the motion system 112 and the rotation of the deposition head 122, is managed by a control system 150. In an exemplary embodiment, the control system 150 comprises a computer numerical controller (CNC), a programmable logic controller (PLC), a robotic controller, or a similar processing unit. The control system is configured to receive a digital toolpath, for example in the form of G-code, from a computer-aided manufacturing (CAM) software package. This toolpath defines the desired trajectory of the deposition nozzle in at least two-dimensional space (e.g., X, Y, Z coordinates). The control system 150 processes this toolpath to generate coordinated motion commands for the motion system's primary axes and for the rotational axis of the rotary union 116. For instance, when depositing along a curved path, the control system calculates the local tangent at the point of deposition and continuously adjusts the rotational position of the deposition head to maintain a desired orientation, such as keeping a compaction roller (e.g., 1010) aligned with the direction of travel. The control system 150 may also be configured to synchronize the material feed rate from the material supply 100 with the deposition head's travel speed to ensure a consistent bead geometry. The control system 150 is illustrated as a box on a wall of the AMM build cell 110. However, it may be disposed on the motion system 112, end effector 120, or remotely within or outside the AMM build cell 110, and may be connected for control of at least the motion system 112 and end effector 120 by wired, wireless, or optical connection known in the art.

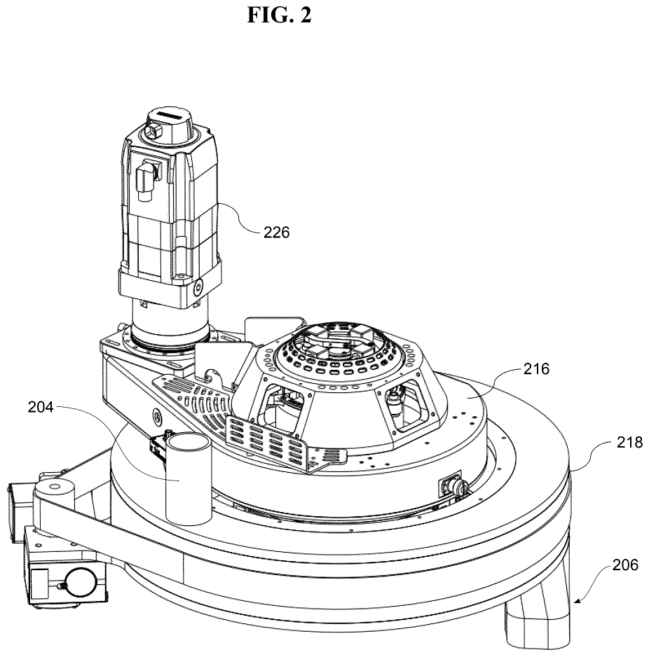

FIG. 1C shows a block diagram illustrating the flow of additive manufacturing material around the rotary union 116 using a material conveyance system 118. The additive manufacturing material first travels from the primary material supply (not shown) to the material conveyance system 118 through the supply-side portion of the material pathway 114. The additive manufacturing material is then moved around the rotary union 116 through the material conveyance system 118 to the delivery-side portion of the material pathway 115. The additive manufacturing material then travels to the deposition head 122 for extrusion. There are many options for conveying the additive manufacturing material through the material pathway, for example pneumatic pressure, vacuum pressure, or gravity from the main/primary material holder. FIGS. 2, 3, 4, and 6 illustrate different methods of conveyance through a material conveyance system.

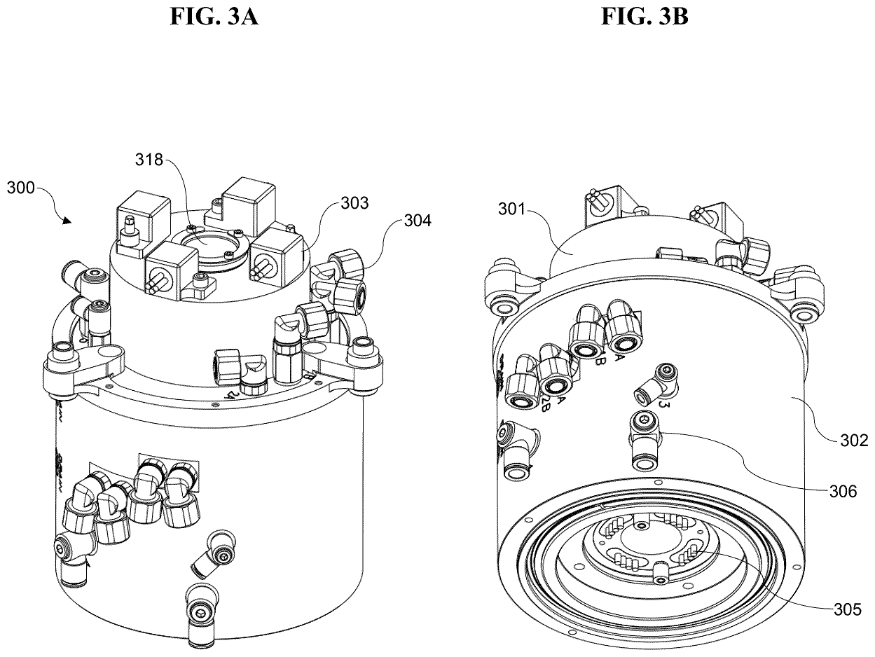

FIG. 2 shows a detailed schematic of a rotary union 216 and an example of a material conveyance system 218. The rotary union 216 is configured to drive rotation of an end effector with a dedicated motor 226. The rotary union 216 also contains a slip ring (e.g., element 300 shown in FIG. 3), configured to transport electrical and pneumatic utilities across the continuously rotatable axis. The rotary union enables continuous rotation, or substantially large rotation in either direction which, in many implementations of this invention further enables the end effector and corresponding deposition head to rotate this same amount. However, the invention applies even to an end effector and corresponding deposition head rotation in a range of 360 degrees or more. The material conveyance system 218, mounted around the rotary union 216, is configured to transfer additive manufacturing material around the rotary union using a conveyance method. This material conveyance system 218 functionally connects the supply-side portion of the material pathway (not shown, e.g., 114) at its inlet 204 to the delivery-side portion of the material pathway (not shown, e.g., 115) at its outlet 206, thereby transferring the additive manufacturing material across the rotating interface of the rotary union 216.

FIG. 3A, and 3B show isometric schematic views of a slip ring 300 with an internal central bore 318, allowing continuous rotation and passage of material to an end effector across a rotary union. Furthermore, this assembly allows passage of electrical and pneumatic utilities through the continuously rotatable rotary union. The slip ring primarily comprises a stator 301, which remains stationary relative to a motion system, and a rotor 302, which rotates freely with an end effector. The stator houses electrical fittings 303 and pneumatic fittings 304. These connections then pass through the continuously rotatable slip ring 300 to the rotor, 302 where corresponding electrical fittings 305 and pneumatic fittings 306 are housed.

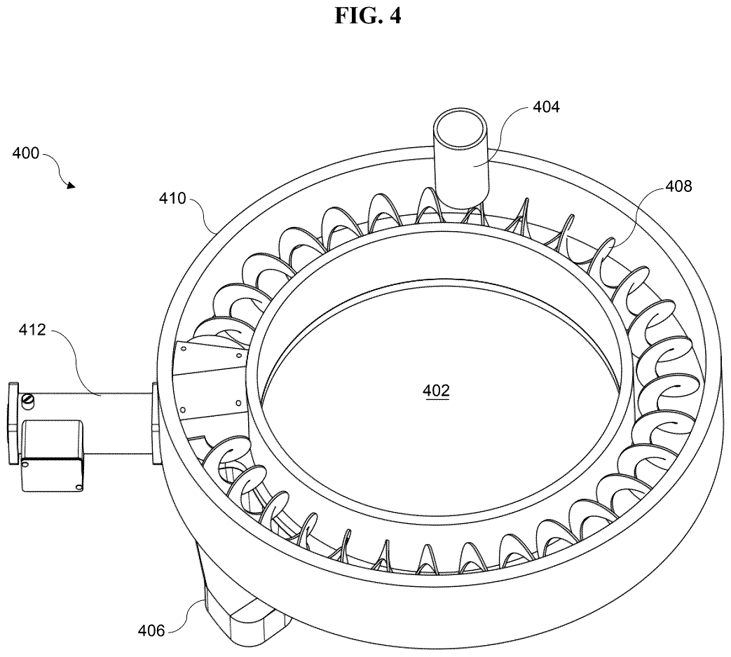

FIG. 4 shows a material conveyance system 400 for additive manufacturing material conveyance. In this embodiment, the material conveyance system 400 uses a flexible auger 408 to convey the additive manufacturing material. The auger assembly is configured in a circular arrangement, creating a central bore 402 specifically designed to accommodate a rotary union (not shown). The pathway is routed externally and circularly around the rotary union to allow rotation in a range of 360 degrees or more. The additive manufacturing material is initially transported from an attached material holder (e.g., 100) through the supply-side portion of the material pathway (e.g., 114) to the material conveyance system inlet 404. The inlet 404 moves directly with the motion system (e.g., 112). Once through the inlet 404, the material is conveyed circumferentially around the bore 402 by the flexible auger 408 to the material conveyance system outlet 406, where it enters the delivery-side portion of the material pathway (e.g., 115).

The conveyance system outlet 406 rotates directly with an end effector (e.g., 120). For clarity, the top portion or cover of the housing 410 is not shown in this view, but it's understood that the housing 410 fully encloses the screw (i.e., auger) 408 to prevent material spillage and contamination. The helical screw 408 is driven by a dedicated motor 412, providing controlled rotational motion. As the flexible helical screw 408 rotates within the housing 410, it positively displaces the material, moving it circumferentially around the bore 402. Importantly, the rotation of the helical screw 408 and the material it conveys is independent of the rotation of the rotary union (not shown). This allows the deposition head to rotate freely while the auger continues to supply material. The housing 410 ensures that the material is contained and prevents spillage or loss during transport. Those skilled in the art will recognize that the auger implemented with a flexible helical screw is just one embodiment of a mechanical conveyance system 400. Other flexible auger designs, or even entirely different mechanical conveyance principles, could be employed within the scope of the invention. Further, those skilled in the art will appreciate that the housing can be implemented using a wide variety of flexible conveyance systems or mechanisms that allow for the necessary movement and rotation of the additive manufacturing material.

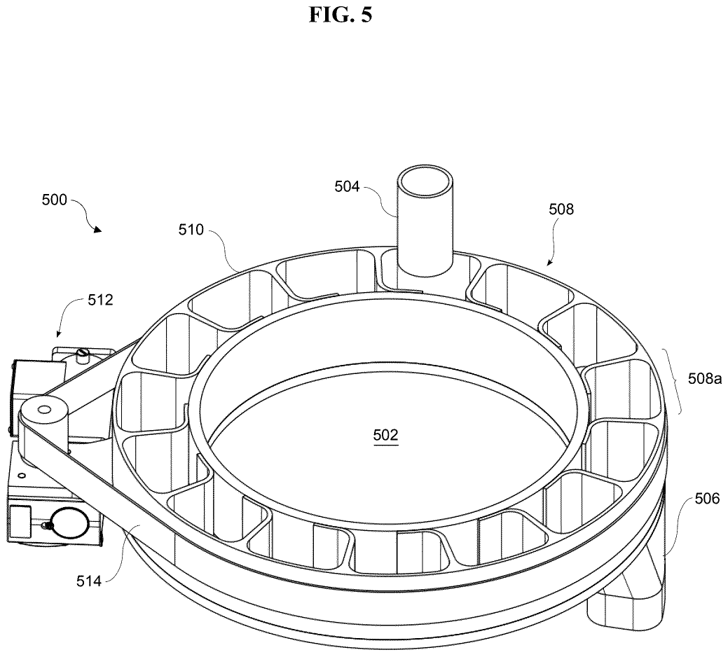

FIG. 5 illustrates an embodiment of a material conveyance system 500 using a sideways-cupped belt mechanism 508 for conveying the additive manufacturing material. This belt mechanism is arranged circularly, defining a central bore 502 designed to accommodate a rotary union (e.g., of FIGS. 3A, 3B). Additive manufacturing material travels from the material supply (e.g., 100) through the supply-side portion of the material pathway (e.g., 114) to the material conveyance system inlet 504. The inlet 504 moves directly with the motion system (e.g., 112).

Upon entering through the inlet 504, the material is conveyed circumferentially around the bore 502 by sideways-oriented cups 508a rotatably coupled to a belt 514. The cups 508a are oriented such that their conveying surfaces (or the conveying surfaces of alternative elements like blades, paddles, or scoops, as described below) are oriented generally tangentially to the direction of rotation around the bore 502. This generally tangential orientation pushes the material forward along the circular path. Alternative conveyance elements, such as blades, paddles, or scoops, could be substituted for the cups, using various implementations of conveyance surfaces while still adhering to the same principle of conveyance around the rotary union (not shown). The conveying surfaces do not necessarily need to be perfectly tangential; other orientations that achieve the desired circumferential material transport around the rotary union (e.g., 300) are also within the scope of the invention. The material is transported to a material conveyance system outlet 506, where it enters the delivery-side portion of the material pathway (114) that moves directly with the rotatable end effector and deposition head (not shown). The sideways-cupped belt mechanism 508 comprises the sideways cups 508a attached to the belt 514 and contained within a housing 510. The belt 514, and therefore the attached cups 508, are rotated circumferentially.

The top portion of the housing 510 is omitted for clarity, but it is understood that the housing substantially encloses the belt and cups to prevent material spillage and contamination. A dedicated motor 512 drives the belt 514, providing controlled and independent rotational motion to the conveyance system. As the belt 514 rotates, the cups 508 positively displace the material, moving it circumferentially around the bore 502. The rotation of the belt 514, the cups 508, and the conveyed material is independent of the rotation of the rotary union (not shown).

This independence allows a deposition head (not shown) to rotate freely while the sideways-cupped belt mechanism continuously supplies material. The housing 510 contains the material, preventing spillage or loss during transport. Alternative mechanisms, including non-belt-based mechanisms, that achieve circular conveyance of material around a rotary union are also within the scope of the invention. It is understood that the principle of using a mechanical conveyor arranged circumferentially around the rotary union can be implemented with other mechanisms, such as paddle systems or other positive displacement conveyors, all of which fall within the scope of this disclosure.

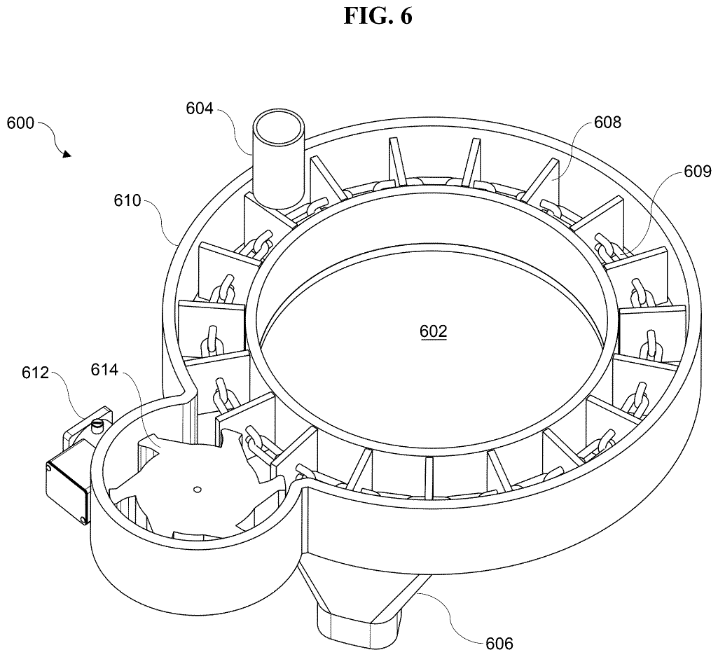

FIG. 6 illustrates another embodiment of a material conveyance system 600 utilizing a continuous chain 609 with attached buckets, paddles, or scoops 608 to transport additive manufacturing material. The chain 609, along with the attached buckets/paddles/scoops 608, is configured to follow a circular path around a central bore 602 where a rotary union (not shown) is intended to be located. The inlet 604 moves directly with machine motion. The outlet 606 moves directly with the continuously rotatable end effector and deposition head (e.g., 120, 122). The additive manufacturing material (not shown) is initially transported from a material supply (e.g., 100) through the supply-side portion of the material pathway (e;g., 114) to the material; inlet 604. Once passed through the inlet 604, the material is moved circumferentially around the central bore 602 by the buckets/paddles/scoops 608. The buckets/paddles/scoops 608 are oriented such that their conveying surfaces are positioned to push the material forward along the circular path.

Alternative conveyance elements and various implementations of conveyance surfaces, while still adhering to the same principle of conveyance around a rotary union, could be substituted. The conveying surfaces do not necessarily need to be perfectly oriented; other orientations that achieve the desired circumferential material transport around a rotary union (not shown) are also within the scope of the invention. Furthermore, a linkage other than a chain, such as a rope, cable, or belt, may be used.

The additive manufacturing material is then positively displaced to the outlet 606, from which it is fed into the delivery-side portion of the material pathway (not shown). The chain 609 and buckets/paddles/scoops 608 are configured to maintain a substantially sealed path around the bore 602. This may involve a housing or shroud (not shown for clarity) that encloses the chain and buckets/paddles/scoops as they travel around a rotary union (not shown). This substantially sealed path prevents material loss and contamination. The system is driven by a motor 612 that rotates a gear 614, which in turn rotates the chained conveyor around the bore 602. The motion of the chain and the conveyance of the material is independent of the rotation of a rotary union (not shown). This allows a deposition head and end effector (e.g., 120, 122) to rotate while additive manufacturing material is being supplied. Various chain and bucket/paddle/scoop configurations are possible, and alternative driving mechanisms can be employed. Other mechanisms that achieve material conveyance around a rotary union are also within the scope of the invention.

In a further embodiment, the principle of the external material conveyance system 400, 500, 600 can be extended to multi-material additive manufacturing. Two or more material conveyance systems, such as the chained conveyor 600, may be arranged around the same rotary union, for example in a stacked or concentric configuration (not illustrated, but those skilled in the art will acknowledge the straightforward combination). Each conveyance system is dedicated to transporting a different additive manufacturing material such as a primary build material and a soluble support material from separate material supplies. Each system would feed a multi-input deposition head, enabling the fabrication of complex parts with overhangs without interrupting the continuous rotation of the end effector.

In another embodiment, the end effector may be configured with a hybrid material supply. A first, bulk material, such as a thermoplastic granulate, may be conveyed from a remote primary material holder (e.g., 100) using one of the disclosed material pathway configurations (e.g., the external conveyor of FIG. 6). Simultaneously, a second material, such as a continuous reinforcement fiber (see FIG. 9 at 914), a colorant, or a chemical additive, may be stored locally on the end effector on a spool or in a small reservoir or the like. This configuration allows the bulk material to be supplied continuously across the rotary interface while the secondary material, which may be consumed at a lower rate, rotates with the deposition head, enabling the creation of composite or multi-component materials on-the-fly.

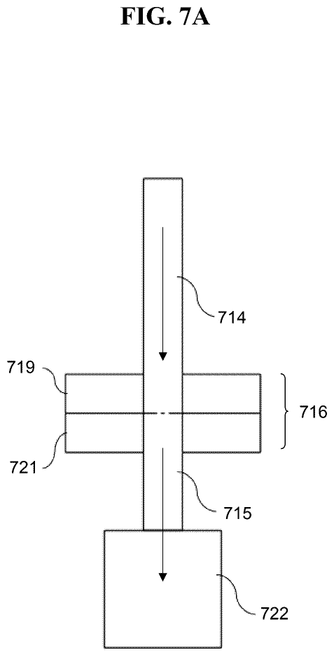

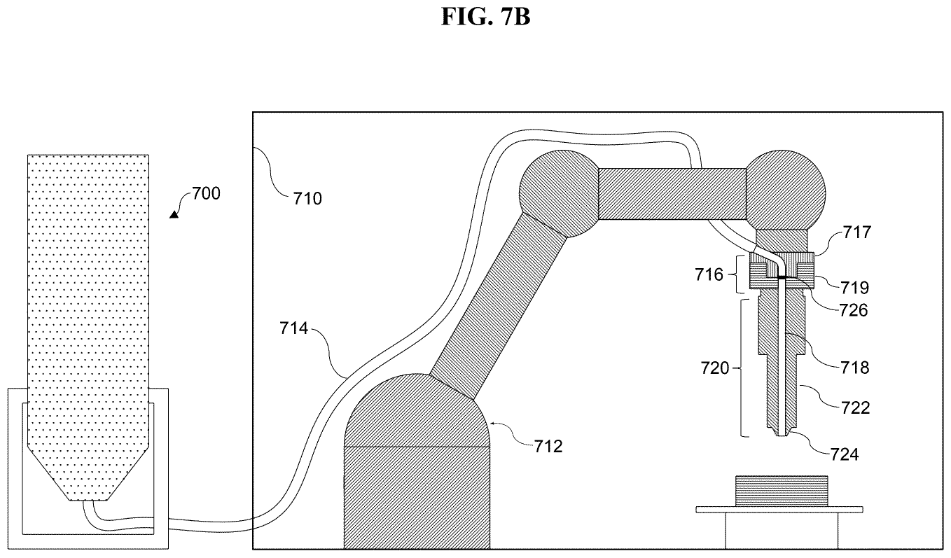

FIG. 7A is a block diagram illustrating the flow of additive manufacturing material through the rotary union 716 using a central bore. The additive manufacturing material first travels from the primary material supply (not shown) to the rotary union 718A though the supply-side portion of the material pathway 714. The additive manufacturing material then is moved through a central bore in the rotary union 716 to the delivery-side portion of the material pathway 715. The additive manufacturing material then travels to the deposition head 722 for extrusion. Furthermore, the stator 719 and the rotor 721 on the rotary union 716 can rotate independently since the additive manufacturing material travels through the central bore. There are many options for conveying the additive manufacturing material through the material pathway, including, but not limited to, pneumatic pressure, vacuum pressure, or gravity for example from the primary material supply.

FIG. 7B presents a cross-sectional, schematic view of an AMM system including a rotary union 716 integrated within an AMM, illustrating a material pathway that passes through the rotary union 716. The AMM comprises a material holder or reservoir 700 located adjacent to, and external to, an AMM build cell 710. Inside the AMM build cell 710 is a motion system 712, a material pathway 714, a rotary union 716 with an internal channel 718, and an end effector 720. Mounted on the end effector 720 is a deposition head 722 with a nozzle 724. The material supply 700 stores additive manufacturing material and may include heating and drying capabilities. The end effector 720 includes the deposition head 722 and the associated nozzle 724 for depositing the additive manufacturing material in a controlled manner. The material pathway 714 connects the material supply 700 to the rotary union 716. This pathway 714 constitutes the supply-side portion of the material pathway. Material from the pathway 714 enters the stator 717 of the rotary union 716 and travels through the internal channel 718 to the rotor 719 of the rotary union 716. From the rotor 719, the material enters a delivery-side portion of the material pathway (e.g., 115), which connects to the deposition head 722. FIG. 7B furthermore shows a rotational coupling 726 between the rotor 719 and stator 717 around the internal channel. A rotational coupling can include, but is not limited to, swivel joints, sealed bearings, and flexible sections with torsional compliance. The rotary union 716 further provides a continuously rotatable mechanical and electrical connection as described for FIG. 3, allowing the end effector 720, including the deposition head 722 and nozzle 724, to rotate in a range of 360 degrees or more relative to the material supply 700 about a rotational axis. The material pathway conveys the additive manufacturing material continuously, regardless of the rotation of the end effector 720. The material conveyance system actively moves the material through the central bore 718 of the rotary union 716, ensuring a consistent supply of additive manufacturing material from the material supply 700 to the deposition head 722. The material conveyance system may employ various mechanisms, including, but not limited to, pneumatic pressure, vacuum pressure, a fluid or hydraulic pressure system, a ram feed system, or gravity. In embodiments with a sufficiently large central bore, mechanical conveyors such as a flexible auger or screw conveyor may also be used. Many different configurations are possible.

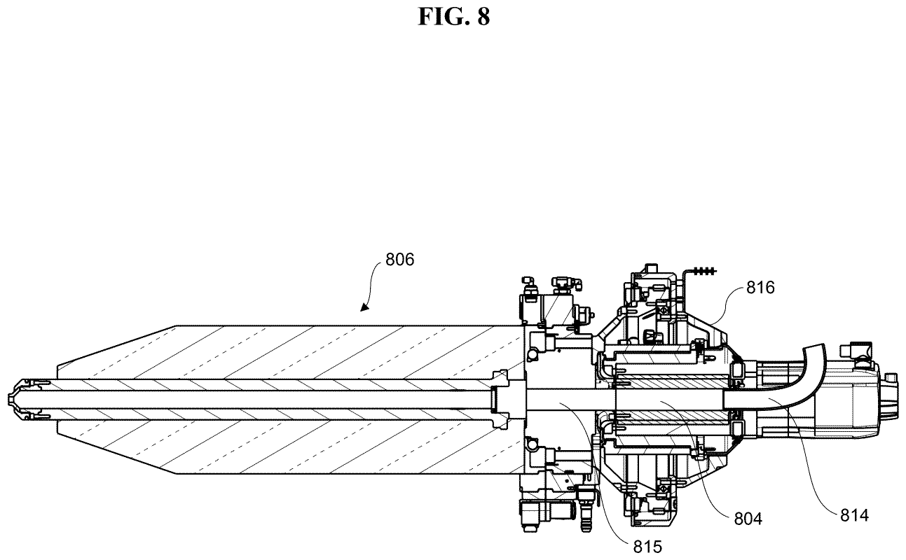

FIG. 8 presents a cross-sectional view of a rotary union 816 and an end effector 806 with an internal channel 804 integrated within an AMM. This figure illustrates one implementation of a material pathway, characterized by the channel 804 passing directly through a central bore (or lumen) of the rotary union 816. The rotary union 816 enables rotation of a deposition head 806 relative to a stationary material supply (not shown), while ensuring consistent electrical and fluid/pneumatic connectivity. The material pathway, in this illustrated implementation, passes through the internal channel 804, a substantially cylindrical void or conduit extending axially through the rotary union's center. The internal channel 804 is dimensioned to accommodate the flow of additive manufacturing material (not shown) without obstruction. The pathway leading to this internal channel 804 from the material supply constitutes the supply-side portion of the material pathway 814, while the pathway leading from the channel 804 to the deposition head 806 constitutes the delivery-side portion of the material pathway 815. Various channel cross-sectional shapes, while described here as substantially cylindrical, are possible. The channel 804 itself can be constructed integrally with the rotary union 816 during its manufacture, or as a separate component, such as a rigid tube or pipe, inserted into a pre-existing central bore. The inner surface of the internal channel 804 is preferably smooth to minimize friction and prevent material damage or clogging. The rotary union 816 may have different configurations of where a rotating member and a stationary member meet. To facilitate these different configurations, the material pathway, specifically the channel 804, may incorporate various types of rotational couplings (not shown) to permit the necessary relative rotation between sections of the channel and other components at or near the rotary union 816. These couplings may be located within the rotary union 816, on either side of the rotary union, or both. These couplings, such as dynamic fluid seals or sealed bearing assemblies, are designed to create a continuous, sealed passage for the material while allowing for low-friction rotation between connecting segments of the pathway.

The internal channel 804 can be considered either a port integrated within the rotary union 816 or, when implemented as a separate component that is inserted, a distinct bore passing through the rotary union's central lumen. It is understood that in other implementations, one or more dedicated ports within the rotary union 816, separate from the central bore, may be used for material transfer instead of the internal channel 804. In such embodiments, the at least one internal passage is disposed offset from the rotational axis of the rotary union. For example, in one configuration, the rotary union includes one or more standard off-axis ports (e.g., side-entry ports on a stator) that fluidly connect to sealed annular channels or grooves, allowing for the continuous transfer of additive manufacturing material (e.g., fluids, gases, or resins) across the rotating interface. In another configuration, the rotary union may be configured with a plurality of discrete internal passages arranged circumferentially around the rotational axis to convey material. This ‘revolver’ configuration provides straight-through conveyance paths offset from the center, which is particularly advantageous for preventing jamming when conveying solid materials like pellets or strands. Alternatively, the internal passage may be configured as a large annular (ring-shaped) void concentric with the rotational axis, allowing for the high-volume flow of suitable materials (e.g., powders or slurries) through a non-central path. For example, a rotary union may be configured with a plurality of discrete internal passages, each fluidly isolated from the others. In one such multi-material embodiment, a first additive manufacturing material may be conveyed through the central bore, while a second additive manufacturing material (which could include, but not be limited to, support material or a colorant) is simultaneously conveyed through one or more separate, off-axis dedicated ports or offset internal passages within the same rotary union. This allows for the simultaneous or sequential transfer of multiple different materials, such as a primary build material and a soluble support material, or two components of a reactive resin system, through the same rotary union to the deposition head. This multi-passage configuration is particularly advantageous for processes involving reactive materials, such as two-part epoxies or resins, where the components must be kept separate until they reach a mixer in the deposition head. By providing isolated, sealed passages through a single rotary union, this embodiment simplifies the end effector design while still enabling full, continuous rotation.

FIG. 9 presents a detailed perspective view of an end effector 900, illustrating several components. A nozzle 904 is mounted on the deposition head 902 of the end effector 900 and is configured to deposit additive manufacturing material. A temperature sensor 906 may be mounted ahead of the nozzle 904 relative to a direction of travel during deposition. The temperature sensor 906 may be used to measure the temperature of previously deposited material 922, also referred to as the substrate and workpiece, for improved bonding. This sensor 906 may be, but is not limited to, an infrared pyrometer, a thermopile, or a thermocouple, and may be arranged at a distance and angle appropriate for the sensor type and any limiting structure.

Also positioned ahead of the nozzle 904, and adjacent to the temperature sensor 906, a localized laser heater 908 may be disposed. This heater 908 provides localized heating of the substrate material (such as a foundation material or previously deposited material 922) immediately before new material is deposited, helping to ensure optimal bonding temperature. In some applications the localized heat source may also be used to further heat the newly deposited additive manufacturing material. Alternative heating methods, such as a hot air blower, an infrared heater, or a conductive heating element, could be used.

Trailing the nozzle 904 is a compaction roller 910, which applies pressure to newly deposited material 924, improving interlayer adhesion and density. The compaction roller 910 may be actively or passively heated or cooled. Alternative compaction or shaping devices, such as a plate or a shoe, or a finishing trowel for smoothing the deposited bead, (not shown) could be used instead of a roller.

The end effector may be configured to hold and/or provide reinforcement material 914. In the application illustrated in FIG. 9, spools of continuous fiber are mounted to the end effector and may feed one or more fiber tows as reinforcement material. A reinforcement applicator 912 is shown positioned to place continuous fiber reinforcement just in advance of the newly deposited material, allowing for the creation of a reinforced composite part. This applicator 912 can be configured for various reinforcing materials, including, but not limited to, continuous fiber, chopped fiber, or other structural enhancements and can further be orientated in an alternative embodiment to trail the newly deposited composite material. The applicator 912 may include mechanisms for feeding, cutting, and tensioning the reinforcement material. The reinforcement applicator 912 could also be implemented to apply reinforcement material after the nozzle 904 onto the recently deposited material layer 924.

Not pictured, but also contemplated by the inventors for inclusion as part of the end effector 900, is a surface treatment applicator positioned ahead of the nozzle 904 to apply a bonding agent, primer, or other surface preparation to the substrate before deposition, potentially improving adhesion. Various surface treatment methods and applicators could be employed. The number and arrangement of components is not limited to the example shown; alternative arrangements and components are possible. For instance, multiple sensors or heaters could be used, or the components could be arranged in a different order or be changed between leading the newly extruded material vs. trailing the newly extruded material for various process reasons. In other embodiments, the end effector 900 may be equipped with additional or alternative process tools. These can include, but are not limited to, a localized gas or fluid jet for rapid cooling or shielding, a plasma torch for surface activation to improve layer adhesion, a vision system for in-situ metrology and defect detection, or even a compact machining spindle for hybrid additive and subtractive operations on the deposited material. The fixed positions of these components relative to the deposition orientation facilitates consistent process control.

The components described, particularly sensors such as the temperature sensor 906, can be integrated into a closed-loop feedback control system. For example, the control system can be configured to receive a real-time temperature reading of the substrate 922 from the sensor 906. The control system may compare this reading to a desired setpoint temperature for optimal layer-to-layer bonding. If the measured temperature is below the setpoint, the control system can automatically increase the power output of the localized laser heater 908 or decrease the travel speed of the deposition head to allow for more heating time. Conversely, if the temperature is too high, the controller can reduce the heater's power. This closed-loop control allows the system to adapt to changing thermal conditions during a build, thereby improving part quality, consistency, and mechanical performance. Other sensors, such as optical inspection cameras or laser profilometers, could be similarly integrated to provide feedback for controlling bead geometry, surface finish, or dimensional accuracy. Furthermore, these feedback loops may be interconnected; for example, a laser profilometer measuring bead height could provide feedback to not only adjust material flow rate but also to dynamically control the pressure applied by the compaction roller 910 to achieve a target layer density.

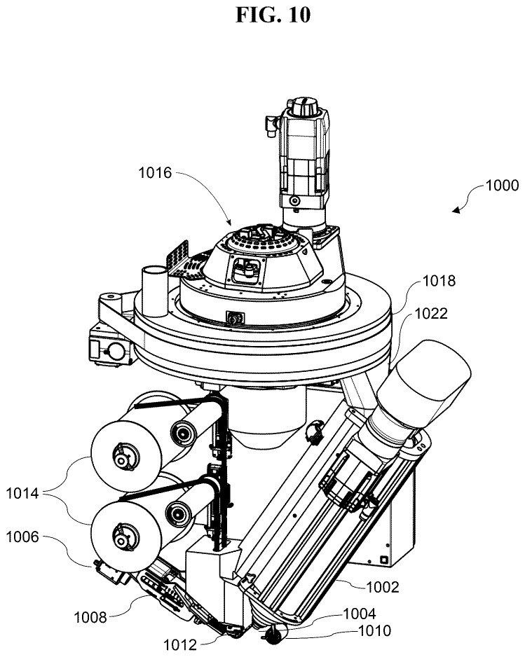

FIG. 10 shows an isometric schematic of an additive end effector 1000, such as the one (900) described in FIG. 9, in a state of depositing additive manufacturing material onto a workpiece substrate (not shown). This end effector 1000 includes a nozzle 1004, a temperature sensor 1006 positioned ahead of the nozzle, a localized laser heater 1008 adjacent to the temperature sensor, and a compaction roller 1010 trailing the nozzle. Also included is a reinforcement applicator 1012 configured to place reinforcement material 1014, such as continuous fiber, ahead of the deposited material. As discussed above in the description of FIG. 9, a surface treatment applicator (not pictured) could be included ahead of the nozzle 1004. The end effector 1000 is assumed to be rotatable in a range of at least 360 degrees relative to the motion system (e.g., 112, not shown in FIG. 10), allowing the various components to be mounted directly on the end effector and remain in line with the deposition path, regardless of the deposition orientation. One could reasonably understand that other process treatment devices could be added to the overall structure of the end effector. Due to the continuous rotatability and steering capabilities of the end effector 1000, such process treatment devices can be mounted directly on the end effector 1000, in line with the deposition path. The end effector 1000 is also equipped with a material conveyance system 1018, configured to transport additive manufacturing material around the rotary union 1016 to the start of the delivery-side portion of the material pathway 1022 that feeds the deposition head.

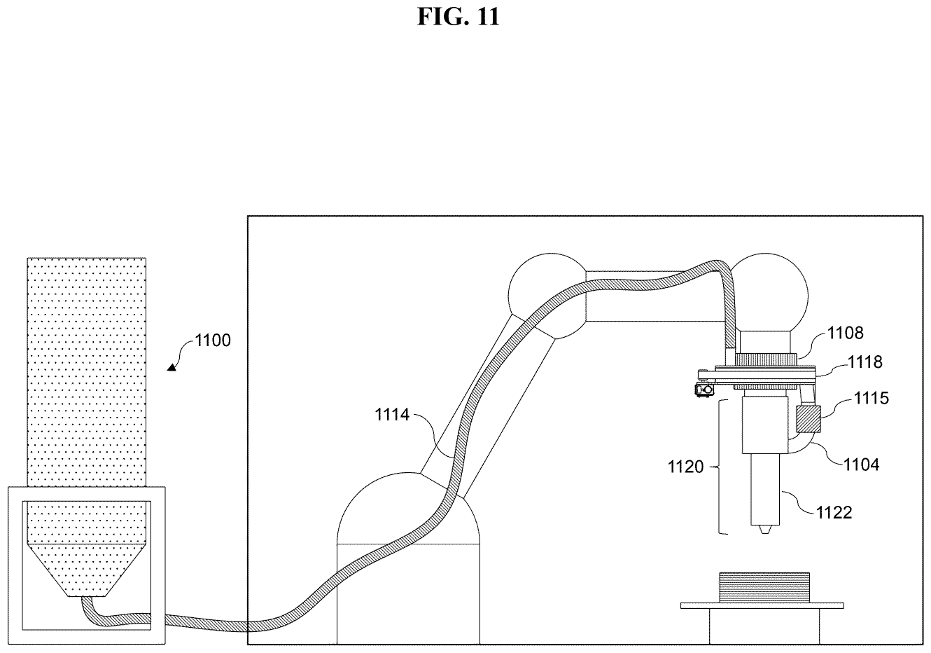

FIG. 11 shows a schematic diagram of an AMM with a two-stage material supply. The primary material holder 1100 provides a large-capacity storage of additive manufacturing material. The primary material holder 1100 may be located remotely from the AMM. In the illustrated embodiment, an end-effector material holder 1115 is located on the end effector 1120 and is substantially closer to the deposition head 1122 than the primary material holder 1100. The end-effector material holder 1115 acts as a decoupling buffer, holding a readily available supply of material proximate to the deposition head 1122 and ensuring a consistent material feed even during continuous rotation of the end effector 1120. This end-effector material holder, or buffer, 1115 can be configured as a standalone component mounted on the end effector 1120, such as a heated mini-hopper that gravity-feeds the deposition head 1122. In an embodiment, the end-effector material holder/buffer 1115 is configured as a hybrid pressurized material supply.

Rather than relying solely on gravity, the end-effector material holder/buffer 1115 incorporates a motive force—such as a pneumatic piston, a ram-feed mechanism, or a pressurized bladder—to actively force the additive manufacturing material into the deposition head's intake 1104. This pressurized configuration ensures a consistent and uninterrupted material feed rate regardless of the end effector's orientation in 3D space, effectively enabling 5-axis or multi-axis printing where the deposition head 1122 may operate in horizontal or inverted positions. Alternatively, in another embodiment, the end-effector material holder/buffer 1115 is integrated directly into the deposition head 1122 itself. For example, in a pellet-fed extruder, a feed throat and an upper, non-melting section of an extruder barrel can be intentionally oversized to serve as this integrated end-effector material holder/buffer, eliminating the need for a separate hopper on the end effector 1120. The end-effector material holder/buffer 1115 may include its own heating, drying, and metering capabilities. These capabilities ensure the additive manufacturing material is maintained at the optimal temperature and moisture content, and that the feed rate to the deposition head is precisely controlled. In this embodiment, the end-effector material holder 1115 is substantially smaller and lighter than the primary material holder 1100, thus enabling the end effector 1120 to continuously rotate about the rotary union 1108 without substantially increasing its size, weight, or inertia. Furthermore, the two-stage approach may further decouple the bulk material handling at the primary material holder 1100, including its corresponding material transport 1114 and material conveyance 1118, from the precise feed requirements of the deposition head 1122. This decoupling improves process stability by isolating the deposition head from potential fluctuations in the transmission or conveyance from the primary material holder 1100. Importantly, in this two-stage configuration, the material conveyance system 1118, which can be implemented according to FIG. 1 or FIG. 7, still transfers pellets across or through the rotary union 1108. However, the presence of the end-effector material holder 1115 enables the possibility for this conveyance to be intermittent. This means that additive manufacturing material transfer across the rotary union 1108 can occur only at specific rotary angles, periodically, or on an as-needed basis, rather than continuously.

The control system (150) may be configured to regulate this intermittent supply, for example by actuating the transfer based on a signal from a level sensor (not shown) in the end-effector material holder/buffer 1115. At a minimum, the intermediate system enables a less regular material transfer across the rotary union. This can provide a significant advantage in terms of system complexity and robustness.

The concept of an end-effector material holder 1115 acting as a buffer storage is not limited to the two-stage embodiment and can be applied to any of the disclosed material pathway configurations, including the external conveyor or flexible pathway embodiments, to provide a consistent material pressure at the deposition head. It will be appreciated that the specific configuration of the two-stage supply system can vary, and that a single-stage or multi-stage (more than two stages) system could also be employed. The key concept is to provide a controlled and consistent supply of additive manufacturing material to the deposition head, regardless of the configuration used.

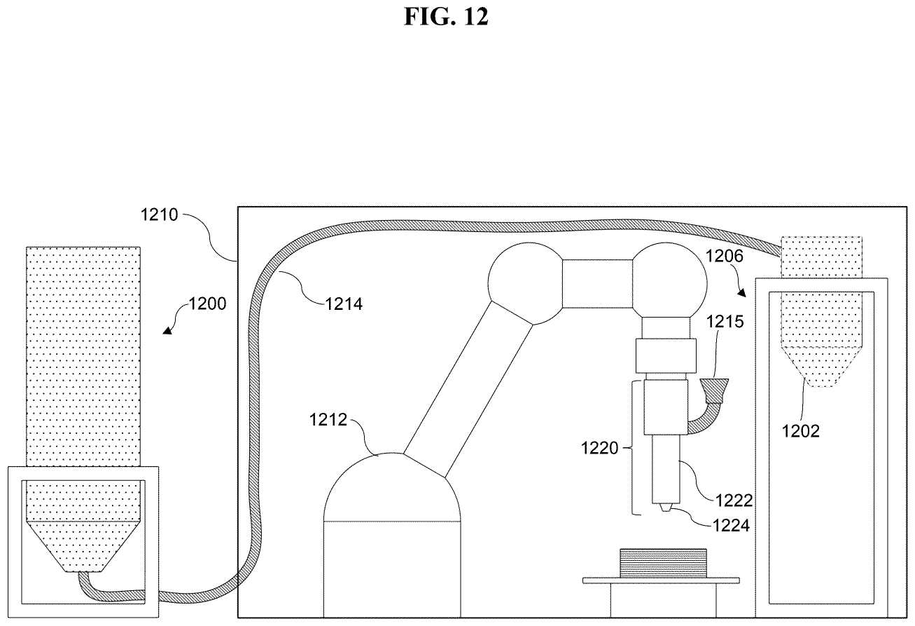

FIG. 12 shows a schematic layout of an AMM cell, illustrating a further possible implementation of a two-stage material supply. In this embodiment, an end-effector material holder 1215, located on an end effector 1220, is replenished indirectly from a primary material holder 1200 at one or more end-effector material supply transfer assemblies 1206 within the AMM build cell 1210. Each end-effector material supply transfer assembly 1206 transfers material from the primary material holder 1200 to the end-effector material supply 1215. From there, the additive manufacturing material continues to be transferred to the deposition head 1222 and ultimately is deposited out a nozzle 1224.

The end-effector material supply transfer assembly 1206 may optionally include its own material storage system 1202, and this material storage system may include its own heating and drying capabilities. This assembly 1206 may be fixed, or its position may be adjusted dynamically, potentially based on the expected path of the end effector 1220 during an additive manufacturing build. The material is transferred to the end-effector material holder 1215 either by moving the end-effector material holder 1215 along with the end effector 1220 to a designated replenishment point, or by moving the end-effector material supply transfer assembly 1206 itself to the end-effector material holder 1215. This provides flexibility in material transfer. Various locations are possible for the end-effector material supply transfer assembly 1206, including on the AMM motion system 1212 itself, inside the AMM build cell 1208 separate from the motion system 1212, or in a designated location outside the AMM build cell 1210. In an alternative embodiment, the end-effector material supply transfer assembly 1206 may be configured to perform a complete exchange or swap, wherein a depleted end-effector material holder 1215 is removed from the end effector and replaced with a different, pre-filled replacement unit. This allows for rapid material changeover or replenishment.

A key aspect of this configuration is that the end-effector material supply transfer assembly 1206 can be located in a fixed or relatively fixed, non-rotating position within the AMM build cell 1210. The end effector 1220 moves to this end-effector material supply transfer assembly for replenishment. A replenishment action constitutes the transfer of material from the stationary, supply-side portion of the material pathway 1214 (originating at primary material holder 1200) to the rotating delivery-side portion of the material pathway, which begins at the end-effector material holder 1215. There could be multiple transfer assemblies 1206 within the AMM build cell 1210 or proximate thereto, to optimize the process.

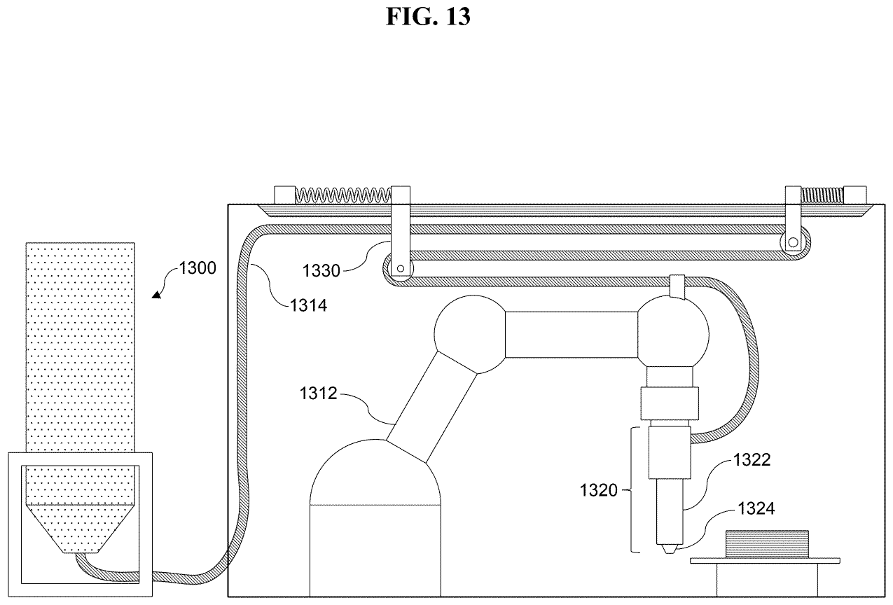

FIG. 13 shows a schematic overview of an alternative embodiment of an AMM that achieves continuous rotation in a range of 360 degrees or more of an end effector 1320 and deposition head 1322. In this embodiment, the AMM comprises a material holder 1300, the deposition head 1322 with a nozzle 1324, a robotic arm motion system 1312, and a flexible material pathway 1314. The material holder 1300 is similar to those described in previous embodiments. A key distinction to other embodiments is the configuration of the material pathway 1314. The material pathway 1314 comprises a flexible tube or conduit that has a significantly greater length than the direct distance between the material holder 1300 and the deposition head 1322. This extra length is deliberately arranged in a coiled, looped, or otherwise non-linear configuration, herein referred to as a service loop, to accommodate the rotation of the deposition head 1322. A support system 1330 manages the flexible material pathway 1314, maintaining the service loop in its non-linear configuration. Examples of this support system 1330 include, but are not limited to, cable carriers (energy chains) that guide and protect the feed tube while allowing multi-axis movement; passive cable management systems with elastic tensioners, such as spring-loaded reels or pulleys, to maintain controlled slack; compliant linkage systems that absorb strain while tracking the deposition head's motion; overhead booms with gimbal suspension for pivoting and tracking; motorized cable reel systems that actively spool and unspool the feed tube in sync with the deposition head's movement; track-guided feed tube systems using rails to constrain movement along a defined path; and flexible spiral wraps or slotted tubes that provide a compact, tangle-free conduit. These mechanisms enable the feed tube to follow the deposition head's motion, including rotation, while ensuring uninterrupted material flow. The flexible material pathway 1314 itself may be constructed from a variety of materials selected for durability, low friction, and resistance to kinking, such as polymer tubing (e.g., PTFE, polyurethane), reinforced hose, or flexible metal conduit. As the deposition head 1322 rotates, the flexible material pathway 1314 flexes and bends, facilitated by the support system 1330, which accommodates the flexing and changing geometry of the service loop, allowing for continuous rotation while maintaining a continuous material pathway. This ensures that the conduit remains open and unrestricted for material conveyance regardless of the deposition head's orientation, effectively preventing occlusion. The support system 1315 ensures that the service loop maintains a minimum bend radius sufficient to prevent occlusion during all stages of rotation. The support system 1330 prevents kinking, binding, or excessive stress on the material pathway 1314 during rotation. A motive force, such as a pneumatic, vacuum, or mechanical system, may move the material through the pathway 1314.

In the illustrated embodiment, the supply-side portion of the material pathway 1314 is the segment of the flexible pathway 1314 extending from the material holder 1300 to the stationary input of the support system 1330. The delivery-side portion of the material pathway is the segment of the flexible pathway 1314 that is actively managed by the support system 1315 and connects to the deposition head 1322, allowing it to rotate freely. While current AMM systems often include a flexible material pathway consisting of conduit along with a support system, they are not designed in a way to enable continuous rotation within a range of 360 degrees or more of the deposition head relative to the material supply system.

While the invention has been described in terms of various embodiments, those skilled in the art will recognize that the invention can be practiced with modification within the spirit and scope of the appended claims.

What is claimed is:

1. An additive manufacturing machine (AMM) comprising:
a material holder configured to supply an additive manufacturing material;
a deposition head configured to receive the additive manufacturing material from the material holder and deposit the additive manufacturing material on a substrate or workpiece;
a motion system configured to move the deposition head and position the deposition head in at least two-dimensional space;
a rotary union having a first portion and second portion, the second portion being operatively coupled to the deposition head and rotatable with respect to the first portion;
a control system configured to control rotation of the deposition head about a rotational axis, wherein the rotary union is configured to facilitate the rotation of the deposition head about the rotational axis within a rotation range of at least 360 degrees; and
a material pathway disposed and configured to convey the additive manufacturing material from the material holder via a first, supply-side portion of the material pathway across the rotary union to a second, delivery-side portion of the material pathway at or proximate the deposition head, the delivery-side portion of the material pathway being rotatable with the deposition head about the rotational axis.

2. The additive manufacturing machine of claim 1, wherein the rotary union is configured to facilitate transfer, across a rotating interface to the deposition head, of one or more of: electrical power, data/control signals, a gas, and a liquid.

3. The additive manufacturing machine of claim 1, wherein the deposition head is configured to perform at least one of: extruding the additive manufacturing material, mixing and extruding the additive manufacturing material, automated fiber placement with the additive manufacturing material, jetting the additive manufacturing material, selective metering of the additive manufacturing material, and directing energy to consolidate the additive manufacturing material, depositing the additive manufacturing material, and shaping the additive manufacturing material during or after deposition and is configured to process the additive manufacturing material in a format including one or more of: particulate, fluid, semi-fluid, powder, granules, pellets, flakes, chopped fiber, noodles, slugs, strands, fluid, paste, gel, slurry, emulsion, suspension, resin, and wax, filament, continuous fiber, wire, tow, tape, rods, sheet, and bars.

4. The additive manufacturing machine of claim 1, wherein the deposition head is configured to dispense the additive manufacturing material while rotating to maintain an orientation substantially aligned to the local tangent of a non-linear path at the point of deposition, and further including one or more process tools mounted to maintain common rotational movement with the deposition head including one or more of: a monitoring component, a control component, a sensor, an inspection device, a heating element, a cooling element, a surface treatment applicator, a finishing trowel, a roller, a compactor, and a reinforcement applicator, each mounted to maintain common rotational movement with the deposition head.

5. The additive manufacturing machine of claim 1, wherein the material pathway includes a conveyor system including one or more of: a flexible auger, a belt conveyor, a chained conveyor, a screw conveyor, driven cups, paddles, blades, a pneumatic pressure system, a vacuum pressure system, a fluid pressure system, a hydraulic pressure system, a ram feed system, and a gravity-fed system.

6. The additive manufacturing machine of claim 1, wherein the material pathway includes an additive manufacturing material buffer storage positioned proximate to the deposition head.

7. The additive manufacturing machine of claim 1, wherein the material supply is configured to supply the additive manufacturing material at least intermittently, and wherein the control system is further configured to regulate the at least intermittent supply of the additive manufacturing material.

8. The additive manufacturing machine of claim 1, wherein the material pathway extends through the rotary union via at least one internal passage, the at least one internal passage including at least one of:
a port integrated within the rotary union;
a channel extending through a substantially central bore of the rotary union; and
one or more passages disposed offset from a rotational axis of the rotary union.

9. The additive manufacturing machine of claim 1, wherein the AMM is configured to process at least two additive manufacturing materials, and wherein the deposition head includes at least one of:
a mixer for combining the at least two additive manufacturing materials into a resultant material prior to deposition;
a co-extrusion nozzle for simultaneously depositing the at least two additive manufacturing materials as a single, composite extrudate; and
a reinforcement applicator for placing a reinforcement material in combination with a simultaneously deposited matrix material.

10. An additive manufacturing machine (AMM) comprising:
a primary material holder configured to supply an additive manufacturing material;
an end-effector material holder mounted on an end-effector of the AMM, and configured to receive the additive manufacturing material from the primary material holder;
a deposition head operably connected to the end-effector and configured to receive the additive manufacturing material from the end-effector material holder and to deposit the additive manufacturing material on a substrate or workpiece;
a motion system configured to move the deposition head and position the deposition head in at least two-dimensional space;
a rotary union operatively coupled to the deposition head;
a control system configured to control rotation of the deposition head about a rotational axis in a range of 360 degrees or more; and
a transfer mechanism configured to at least intermittently replenish or replace the end-effector material holder with additive manufacturing material from the primary material holder.

11. The additive manufacturing machine of claim 10, wherein the rotary union is configured to facilitate transfer, across a rotating interface to the deposition head, of one or more of: electrical power, data/control signals, gases, and liquids.

12. The additive manufacturing machine of claim 10, wherein the deposition head is configured to perform at least one of: extruding the additive manufacturing material, mixing and extruding the additive manufacturing material, automated fiber placement with the material, jetting the additive manufacturing material, and directing energy to consolidate the additive manufacturing material, depositing the additive manufacturing material, and shaping the additive manufacturing material during or after deposition and is configured to process additive manufacturing material in a format including one or more of: particulate, fluid, semi-fluid, powder, granules, pellets, flakes, chopped fiber, noodles, slugs, strands, paste, gel, slurry, emulsion, suspension, resin, wax, filament, continuous fiber, wire, tow, tape, rods, sheet, and bars

13. The additive manufacturing machine of claim 10, wherein the deposition head is configured to dispense the additive manufacturing material while rotating to maintain an orientation substantially aligned to the local tangent of a non-linear path at the point of deposition, and further including one or more process tools mounted to maintain common rotational movement with the deposition head including one or more of: a monitoring component, a control component, a sensor, an inspection device, a heating element, a cooling element, a surface treatment applicator, a finishing trowel, a roller, a compactor, and a reinforcement applicator, each mounted to maintain common rotational movement with the deposition head.

14. The additive manufacturing machine of claim 10, wherein the transfer mechanism is configured to perform, at a defined location;
transfer of the additive manufacturing material to the end-effector material supply device; and/or
replacement of the end-effector material holder with a pre-filled replacement end-effector material holder;
wherein the defined location includes at least one of:
a fixed location relative to the machine,
a location defined by a position of a machine axis, and
a location based on a path of the deposition head.

15. An additive manufacturing machine comprising:
a material holder configured to supply an additive manufacturing material;

1. a deposition head configured to receive the additive manufacturing material from the material holder and deposit the additive manufacturing material on a substrate or workpiece, and further configured to extrude the additive manufacturing material, mix and extrude the additive manufacturing material, jet the additive manufacturing material, direct energy to consolidate the additive manufacturing material, deposit the additive manufacturing material, and/or shape the additive manufacturing material during or after deposition;
a motion system configured to move the deposition head and position the deposition head in at least two-dimensional space;
a flexible material pathway extending between the material holder and the deposition head; the flexible material pathway has a length greater than a linear distance between the material holder and the deposition head to define a service loop;
a support system configured to maintain the service loop in a non-linear configuration; and
a control system configured to rotate the deposition head about a rotation axis within a rotation range of at least 360 degrees, wherein the support system accommodates a changing arrangement of the service loop to supply the additive manufacturing material to the deposition head while the deposition head rotates and maintains a continuous material pathway.

16. The additive manufacturing machine of claim 15, wherein the support system includes at least one of: a cable carrier, an energy chain, a passive cable management system including elastic tensioners, a spring-loaded reel, a compliant linkage system, an overhead boom with gimbal suspension, a motorized cable reel system, a track-guided feed tube system, and a flexible spiral wrap.

17. The additive manufacturing machine of claim 15, further comprising a rotary union, wherein the rotary union is configured to facilitate transfer, across a rotating interface to the deposition head, of one or more of: electrical power, data/control signals, a gas, and a liquid.

18. The additive manufacturing machine of claim 15, wherein the deposition head is configured to perform at least one of: extruding the additive manufacturing material, mixing and extruding the additive manufacturing material, automated fiber placement with the additive manufacturing material, jetting the additive manufacturing material, selective metering of the additive manufacturing material, and directing energy to consolidate the additive manufacturing material, depositing the additive manufacturing material, and shaping the additive manufacturing material during or after deposition and is configured to process the additive manufacturing material in a format including one or more of: particulate, fluid, semi-fluid, powder, granules, pellets, flakes, chopped fiber, noodles, slugs, strands, fluid, paste, gel, slurry, emulsion, suspension, resin, wax, filament, continuous fiber, wire, tow, sheets, and tape.

19. The additive manufacturing machine of claim 15, wherein the deposition head is configured to dispense the additive manufacturing material while rotating to maintain an orientation substantially aligned to the local tangent of a non-linear path at the point of deposition, and further including one or more process tools mounted to maintain common rotational movement with the deposition head including one or more of: a monitoring component, a sensor, an inspection device, a heating element, a cooling element, a surface treatment applicator, a finishing trowel, a roller, a compactor, and a reinforcement applicator, each mounted to maintain common rotational movement with the deposition head.

20. The additive manufacturing machine of claim 15, wherein the material holder is configured to supply the additive manufacturing material at least intermittently, and wherein the control system is further configured to regulate the at least intermittent supply of the additive manufacturing material.

21. A method of additive manufacturing, the method comprising:
operatively coupling a deposition head to an automated manufacturing machine (AMM) using a rotary union that facilitates rotation of the deposition head about a rotational axis;
supplying an additive manufacturing material from a material holder to the deposition head;
moving the deposition head in at least two-dimensional space using a motion system; and
depositing, with the deposition head, the additive manufacturing material on a substrate or workpiece;
wherein the rotary union facilitates rotation of the deposition head about a rotational axis in a range of 360 degrees or more, and wherein said supplying an additive manufacturing material from a material holder to the deposition head includes delivering the additive manufacturing material via a material pathway, the material pathway disposed and configured to convey the additive manufacturing material from a first, supply-side portion of the material pathway across the rotary union to a second, delivery-side portion of the material pathway proximate the deposition head, the delivery-side portion of the material pathway being rotatable with the deposition head about the rotational axis, the supply-side portion of the material pathway being fixed relative to the motion system, wherein the material pathway includes: a pathway disposed externally around the rotary union and/or at least one internal passage within the rotary union.

22. A method of additive manufacturing, the method comprising:
supplying an additive manufacturing material from a main material holder;
depositing the additive manufacturing material from a deposition head;
moving the deposition head in at least two-dimensional space using a motion system;
operatively coupling a rotary union between the motion system and the deposition head;
rotating the deposition head within a range of at least 360 degrees about a rotational axis;
supplying said additive manufacturing material directly to the deposition head from an end-effector material holder mounted on an end-effector of the additive manufacturing machine; and
replenishing the end-effector material holder at least intermittently with additive manufacturing material from the main material holder via a transfer mechanism.

23. A method of additive manufacturing, comprising:
supplying an additive manufacturing material from a material holder to a deposition head via a flexible material pathway having a length greater than a linear distance between the material holder and the deposition head to define a service loop;
moving the deposition head in at least two-dimensional space using a motion system;
rotating the deposition head about a rotation axis within a rotation range of at least 360 degrees;
depositing the additive manufacturing material from the deposition head onto a substrate or workpiece; and
maintaining the service loop in a non-linear configuration and accommodating a changing geometry of the service loop to maintain a continuous material pathway during said movement and rotation.
